(19) United States
(12) Patent Application Publication
(10) Pub. No.: US 2008/0136277 A1
(43) Pub. Date: Jun. 12, 2008

(54) Motor-Pump Unit Having a Wet-Running Electric Motor and a Hydraulic Pump which is Driven by the Electric Motor

(76) Inventor: Hans Esders, Hildesheim (DE)

Correspondence Address: ZARLEY LAW FIRM P.L.C., CAPITAL SQUARE, 400 LOCUST, SUITE 200, DES MOINES, IA, 50309-2350, US

(21) Appl. No.: 11/839,311

(22) Filed: Aug. 15, 2007

(30) Foreign Application Priority Data
Dec. 8, 2006 (DE) 10 2006 057 958.5

(51) Int. Cl. H02K 5/10; H02K 5/04; H02K 5/132; H02K 7/14

(52) U.S. Cl. 310/87; 310/217

(57) ABSTRACT

The invention relates to a motor-pump unit having a wet-running electric motor and a hydraulic pump which is driven by the electric motor. The electric motor has a rotor and a laminated stator core surrounding it. The electric motor is terminated at one end by a connecting cover, and at the opposite end by an end cap. The laminated stator core forms the outer tubular casing of the electric motor, which is bounded at one end by the end cap and at the other end by the connecting cover. The outer surface of the laminated stator core is covered by a shrink sleeve, which overlaps the adjacent outside surfaces of the connecting cover and of the end cap, in a liquid-tight manner.

### BACKGROUND OF THE INVENTION

The invention relates to a motor-pump unit having a wet-running electric motor and a hydraulic pump which is driven by the electric motor, according to the pre characterizing clause of claim 1.

Motor-pump combinations having wet-running electric motors are known, for example, from EP 0 541 337 A1 or EP 0 611 887 B1. The liquid which is fed by the pump is sucked through the electric motor in these units, where it is used for cooling. In this case, it is difficult to achieve adequate sealing. In units such as these, the laminated stator core of the electric motor is conventionally pushed into a tubular casing, which offers mechanical protection and ensures better heat dissipation. FIG. 1 shows schematically the typical design of motor-pump units such as these in which an electric motor 2 and a hydraulic pump 3 are combined. The rotor of the electric motor 2 is connected to the drive shaft 4. The drive shaft 4 and the rotor S are surrounded by the laminated stator core 6 which is pushed into a cylindrical tubular casing 7. The tubular casing 7 is terminated at one end by the end cap 8 and at the opposite end by the connecting cover 9. In the known example, the electric motor and pump are seated one behind the other on a common drive shaft 4. In this case, appropriate bearings 10 are provided in the end cap 8 and in the connecting cover 9, with the drive shaft 4 being passed through the connecting cover 9 in order then to drive the hydraulic pump.

The inlet opening 11 for the suction connection 12 is provided in the end cap 8. The liquid to be fed enters the electric motor 2 through the inlet opening 11 and flows through it along predetermined gaps or channels with the liquid being used to cool the electric motor. The liquid is sucked into the hydraulic pump 3 through suitable inlet openings. Finally, the volume flow emerges from the pump through the outlet opening 14 at the pressure connection 13.

In order to seal the tubular casing 7 a circumferential seal, for example an 0-ring 16, is in each case provided in the end cap 8 and in the connecting cover 9.

The aim of the present invention is to provide a better, lower cost motor-pump unit.

### SUMMARY OF THE INVENTION

According to the invention the aim is achieved by a motor-pump unit according to the pre characterizing clause of claim 1 in that the laminated stator core itself forms the outer tubular casing of the electric motor which is bounded at one end by the end cap and at the other end by the connecting cover and in that the outer surface of the laminated stator core is covered by a shrink sleeve, which overlaps the adjacent outside surfaces of the connecting cover and of the end cap in a liquid tight manner.

This results in a simplified design in which a dedicated tubular casing, the press in of the laminated stator core into this tubular casing, 0-rings and corresponding grooves in the covers at both ends are eliminated. The external shrink sleeve ensures adequate sealing in which case, for example, the shrink sleeve may be in the form of a shrink collar.

The laminated stator core can be connected in various ways to the end cap and to the connecting cover to form a mechanically robust unit. The laminated stator core is advantageously provided with its strength by means of external longitudinal weld beads. It can be pushed into the end cap at one end and into the connecting cover at the other end. The end cap and the connecting cover can be connected to one another by means of tie rods which hold the unit together and if required, absorb axial forces which occur during operation and which would otherwise force the end cap and the connecting cover apart from one another.

The shrink sleeve preferably has an inner coating which is composed of a thermoplastic adhesive which melts during the shrinking process. Additionally or alternatively, a sealing cement compound can be applied to the outside surface before shrinking thus resulting in the unit being hermetically sealed.

In a further refinement of the invention circumferential grooves are provided in the end cap and/or in the connecting cover and ensure particularly good contact between the end cap or the connecting cover on the one hand and the shrink sleeve. Furthermore, sharp edged webs can be formed between the grooves thus, in conjunction with the shrink sleeve, resulting in a particularly good sealing effect.

For repair purposes the shrink sleeve is removed and is replaced by a new one, after assembly of the unit. The shrink sleeve advantageously allows further components such as sensors, signal lines and the like, to be fixed between the laminated stator core and the shrink sleeve, or between the shrink sleeve and one of the outside surfaces of the end cap and connecting cover without any need to provide additional attachment means. If a transparent shrink sleeve is chosen it is then possible, for example, to accommodate the nameplate which must be legible from the outside.

Further features and advantages will become evident from the following description of the exemplary embodiment.

### BRIEF DESCRIPTION OF THE DRAWINGS

FIG. 1 shows the conventional design of a unit with a wet-running electric motor;

FIG. 2 shows a motor-pump unit according to the invention; and

FIG. 3 shows the exemplary embodiment shown in FIG. 2 with grooves in the connecting cover and end cap.

### DETAILED DESCRIPTION OF THE PREFERRED EMBODIMENT

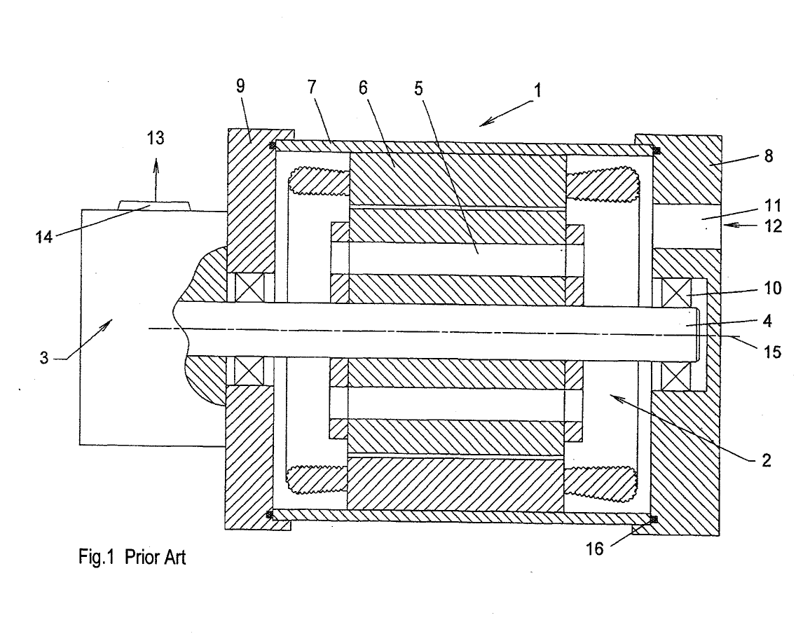

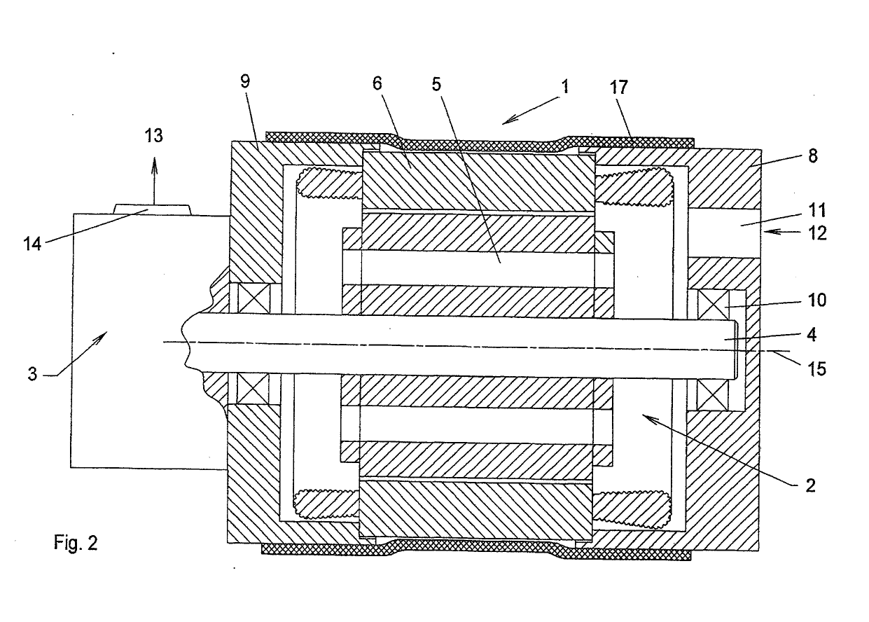

FIG. 2 shows one simple exemplary embodiment of the invention in which in comparison with FIG. 1, the reference numbers have been retained for the same components. The motor-pump unit 1 has an electric motor 2, for example, a three-phase asynchronous machine with a stator winding and a laminated stator core 6 which surrounds the rotor 5 which rotates about the rotation axis 15 with the drive shaft 4. The drive shaft 4 drives a hydraulic pump 3 which is connected to the electric motor 2 via the connecting cover 9.

During operation the electric motor 2 is filled with liquid which is sucked in via the inlet opening 11 and the suction connection 12. This liquid flows through the electric motor 2 where it is used for cooling of the latter and finally enters the pump 3 through an inlet opening that is not illustrated from where it is passed to the outlet opening 14 and to the pressure connection 15.

The casing of the unit is essentially formed by the laminated stator core 6 which when seen in the longitudinal direction of the drive shaft 4 is terminated at both ends by an end cap 8 and a connecting cover 9 in which the bearings 10 for the drive shaft 4 are formed. The tubular laminated stator core 6 is in this example essentially circular-cylindrical, but may have a different shape as well in the outer surface.

The laminated stator core 6 is connected to the end cap 8 and to the connecting cover 9 by clamping, and for example, is pressed into them. The mechanical strength can be increased by welding. For this purpose, by way of example, appropriate longitudinal weld beads 18 (not illustrated in the section drawing in the figure) can be applied to the external circumference of the laminated core 6.

The liquid sealing is produced by a shrink sleeve 17 (if required by a shrink collar) which is pulled over the entire laminated stator core 6 and also overlaps the adjacent outer surfaces of the end cap 8 and connecting cover 9. During the shrinking process the sleeve comes to rest on these outer surfaces of the cover at the end. The sealing effect can furthermore be enhanced by an inner coating composed of a thermo plastic adhesive which melts during the thermal shrinking. Additionally or alternatively, a sealing cement compound can also be applied to the outer surface before shrinking.

The shrink sleeve can also be used to fix further components. By way of example, these may be temperature sensors and signal lines which can in this way be easily and expediently attached to the motor casing. If a transparent shrink sleeve is used this therefore also makes it possible, in particular, to fix the nameplate between the casing and the shrink sleeve such that it can still be read from the outside. If required, the shrink sleeve can easily be mechanically removed and can easily be replaced by a new one, for example, after repair work.

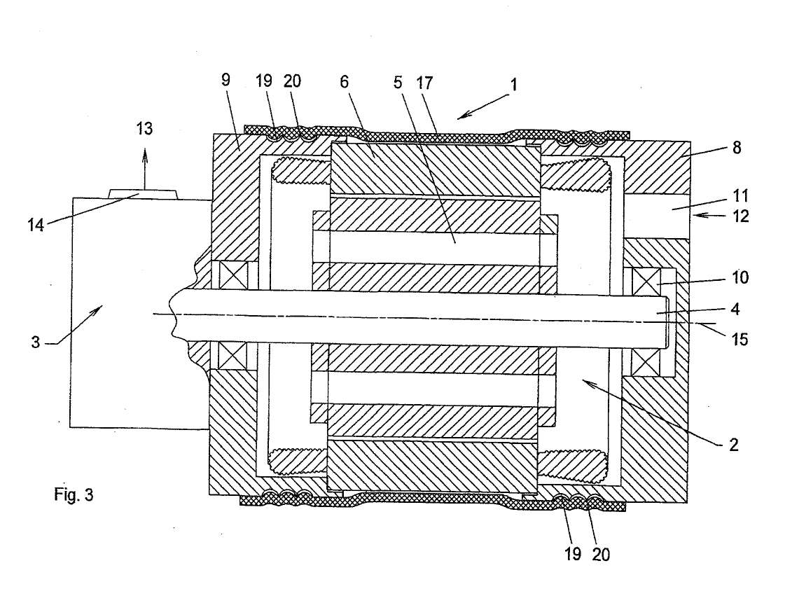

As a development of the exemplary embodiment illustrated in FIG. 2 (reference numbers are retained for the same components), FIG. 3 shows that the configuration of the outer surfaces of the end cap 8 and of the connecting cover 9 makes it possible to further improve the sealing effect. This is because if a plurality of broad circumferential grooves 19 are incorporated in these outer surfaces then a particularly firm contact can be achieved between the shrink sleeve 17 and its contact surfaces. If, in particular, the webs 20 which remain between the grooves 19 are additionally formed with relatively sharp edges then the shrink material 17 is subject to increased stress in the area of these webs 20 thus additionally increasing the sealing effect.

In the simple exemplary embodiments illustrated in FIGS. 2 and 3, the pump 3 is fitted to the connecting cover 9 on the electric motor 2. The electric motor and the pump are in this case arranged one behind the other on a common shaft. However, the invention can also be applied in the same manner to motor-pump units with a high integration level, that is to say in which the pump is partially or entirely integrated in the motor and there may possibly be no drive shaft, or at least no common drive shaft. In all cases, the invention proposes a motor-pump unit which allows considerable manufacturing and servicing savings in comparison to conventional units.

What is claimed is:

1. Motor-pump unit having a wet-running electric motor (2) and a hydraulic pump (3) which is driven by the electric motor (2), with the electric motor (2) having a rotor (5) and a laminated stator core (6) surrounding it, and with the electric motor (2) being terminated at one end by a connecting cover (9) and at the opposite end by an end cap (8), characterized in that the laminated stator core (6) forms the outer tubular casing of the electric motor (2), which is bounded at one end by the end cap (8) and at the other end by the connecting cover (9), and in that the outer surface of the laminated stator core (6) is covered by a shrink sleeve (17), which overlaps the adjacent outside surfaces of the connecting cover (9) and of the end cap (8) in a liquid tight manner.

2. Motor-pump unit according to claim 1, characterized in that the shrink sleeve (17) is formed by a shrink collar.

3. Motor-pump unit according to claim 1, characterized in that the laminated stator core (6) is reinforced by longitudinal weld beads (18).

4. Motor-pump unit according to claim 1, characterized in that the laminated stator core (6) is pushed into the end cap (8) at one end and into the connecting cover (9) at the other end.

5. Motor-pump unit according to claim 1, characterized in that the shrink sleeve (17) has a thermoplastic adhesive as an inner coating.

6. Motor-pump unit according to claim 1, characterized in that a sealing cement compound is applied between the laminated stator core (6) and the shrink sleeve (19)

7. Motor-pump unit according to claim 1, characterized in that circumferential grooves (19) are formed in the outer surfaces of the end cap (8) and/or of the connecting cover (9) in order to improve the contact between the end cap (8) and/or connecting cover (9) and the shrink sleeve (17).

8. Motor-pump unit according to claim 7, characterized in that sharp-edged webs (20) are formed between the grooves (19).

9. Motor-pump unit according to claim 1, characterized in that the shrink sleeve (17) is transparent.

10. Motor-pump unit according to claim 1, characterized in that the shrink sleeve (17) allows further components to be fixed between the laminated stator core (6) and the shrink sleeve (17), or between the shrink sleeve (17) and one of the outside surfaces of the end cap (8) or connecting cover (9).
